(19) United States
(12) Patent Application Publication
(10) Pub. No.: US 2009/0137766 A1
(43) Pub. Date: May 28, 2009

(54) Silicone Particle with Excellent Hydrophobic and Alkali Proof Properties, Method for Preparing the Same and Coating Composition Using the Same

(75) Inventors: Han Su LEE, Uiwang-si (KR); Ju Sung KIM, Uiwang-si (KR); Keun Cheol LEE, Uiwang-si (KR); Kyung Hyun BAEK, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/275,310

(22) Filed: Nov. 21, 2008

(30) Foreign Application Priority Data
Nov. 23, 2007 (KR) 2007-120093

(51) Int. Cl. C08G 77/16

(52) U.S. Cl. 528/43; 528/10

(57) ABSTRACT

Disclosed herein is a silicone particle with excellent hydrophobic and alkali proof properties. The present invention provides a method of controlling surface hydroxyl groups by treating the surface of silicone particles with alkali metal ions or alkaline earth metal ions. The present invention also provides a coating composition using the silicone particle, in which the amount of hydroxyl groups present on the surface of the silicone particle can be controlled.

### CROSS-REFERENCE TO RELATED APPLICATION

This application claims priority from Korean Patent Application No. 10-2007-120093 filed on Nov. 23, 2007 in the Korean Intellectual Property Office, the disclosure of which is incorporated herein by reference in its entirety.

### FIELD OF THE INVENTION

The present invention relates to a silicone particle with excellent hydrophobic and alkali proof properties, a method for preparing the same and a coating composition using the same.

### BACKGROUND OF THE INVENTION

Silicone particles such as silica, polyorganosilsesquioxane particles, and the like are widely used in various industries. Among these, polyorganosilsesquioxane fine particles are widely used as additives for resins or coating agents due to their good compatibility with polymeric materials or organic solvents. Recently, polyorganosilsesquioxane fine particles have been used as diffusing agents for diffuser plates used in LCD-TVs, since they have a low refractive index and good compatibility with resins. These silicone fine particles can be prepared in the form of monodisperse particles by a conventional sol-gel method, such as disclosed in Japanese Patent Nos. 1,095,382, 1,789,299, and 2,139,512, and Korean Patent No. 0756676.

When a sol-gel method is used to prepare silicone fine particles, hydroxyl groups are present on the surface of the resulting silicone particles. However, the surface hydroxyl groups may lower compatibility of silicone particles with polymeric materials or organic solvents. In addition, surface hydroxyl groups may cause many problems during resin molding processes by producing volatile materials.

Silicone particles can be heat treated at high temperatures to eliminate surface hydroxyl groups. However, the thermal treatment operation requires a long period of time and it is difficult to control the amount of surface hydroxyl groups on silicone particles.

Furthermore, silicone particles prepared by sol-gel methods have a disadvantage in that a siloxane bond thereof easily dissolves in alkaline solution, which limits their use in coating applications. Although there are methods for producing polymer-based coating layers on the surface of silicone particles, such methods have a drawback of high production costs.

### SUMMARY OF THE INVENTION

One aspect of the invention provides a silicone particle with excellent hydrophobic and alkali proof properties. In various embodiments of the invention, the silicone particle is surface treated with alkali metal ion or alkaline earth metal ion to provide the silicon particle with an OH index of about 0.6 or less. In exemplary embodiments of the invention, the silicone particle can have an OH index ranging from about 0.0001 to about 0.5. The silicone particle of the present invention also does not substantially dissolve in about 20% NaOH solution at room temperature at least for about 6 hours.

In exemplary embodiments of the present invention, the silicone particles may have an average particle diameter of about 0.1 to about 10 μm.

In exemplary embodiments of the present invention, the silicone particles may have a specific surface area not less than about 7.5 m²/g.

In an exemplary embodiment of the present invention, the silicone particles may be polyorganosilsesquioxane particles.

Another aspect of the invention provides a method for preparing silicone particle with excellent hydrophobic and alkali proof properties. The method comprises mixing alkali metal ions or alkaline earth metal ions with a silicone particle suspension, and filtering and drying the mixture.

In exemplary embodiments of the present invention, the alkali metal ions or alkaline earth metal ions may be KOH, NaOH or a combination thereof.

In exemplary embodiments of the present invention, the alkali metal ions or alkaline earth metal ions may be added in an amount of about 70 to about 20,000 ppm per total weight of silicone particles present in the suspension.

In an exemplary embodiment of the present invention, the silicone particle suspension may be prepared by hydrolysis and condensation reaction of organotrialkoxysilane in an aqueous phase.

Another aspect of the invention provides a coating composition using the surface-treated silicone particles.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

### Silicone Particles

Silicone particles according to the present invention have an OH index of about 0.6 or less as defined by the following equation:

OH Index=Abs(Si—OH)/Abs(Si—CH₃)

wherein Abs(Si—OH): Si—OH peak at 3,300 to 3,700 cm⁻¹, and Abs(Si—CH₃): Si—CH₃ peak at 2,900 to 3,100 cm⁻¹.

The OH index is a value obtained by dividing a Si—OH peak value in an infrared spectrum range of about 3,300 to about 3,700 cm⁻¹ by a Si—CH₃ peak value in an infrared spectrum range of about 2,900 to about 3,100 cm⁻¹. The amount of surface hydroxyl groups on the surface of the silicone particles may be analyzed by an IR (infrared) analysis. The relative amount of surface hydroxyl groups can be determined by using an OH index obtained according to the above equation, and an optimal concentration range of hydroxyl groups can be measured and analyzed by the absorption concentration of hydroxyl groups on the surface of the silicone particles. When the OH index value increases, the amount of surface hydroxyl groups becomes larger and the silicone particles become more hydrophilic. When the OH index value decreases, the amount of surface hydroxyl groups becomes smaller and the silicone particles become more hydrophobic.

In exemplary embodiments of the present invention, the OH index may be about 0.6 or less, for example about 0.0001 to about 0.5, and as another example about 0.05 to about 0.5. When the OH index is less than about 0.6, the silicone particles may acquire sufficient hydrophobic and alkali proof properties.

In exemplary embodiments, the silicone particles of the present invention do not substantially dissolve when they are allowed to stand in about 20% NaOH solution at room temperature at least for about 6 hours. In exemplary embodiments of the invention, as used herein the term “do not substantially dissolve” refers to zero up to about 5% weight loss of the silicone particles when left in an about 20% NaOH solution for at least about six hours. In exemplary embodiments, if left in about 20% NaOH solution for more than 6 hours, at most about 5% of the initial weight of the silicone particles of the invention dissolves in about 20% NaOH solution.

The silicone particles of the present invention have a unit represented by the following Formula 1.

RSiO_{1.5-x}(OH)ₓ [Formula 1]

wherein R is an alkyl group having 1 to 6 carbon atoms, a vinyl group or an aryl group having 6 to 20 carbon atoms, and x is about 0 to about 1.5.

In exemplary embodiments of the invention, R is a methyl group, an ethyl group, or a phenyl group. In the above Formula 1, OH groups may be present in both the inside and the surface of the particles. OH groups on the surface of the particles (hereinafter referred to as “surface hydroxyl group”) have an important effect on the compatibility of the particles with polymeric materials or solvents.

In an exemplary embodiment of the present invention, the silicone particles may have an average particle diameter of about 0.1 to about 10 μm.

In exemplary embodiments of the present invention, the silicone particles may have a specific surface area not less than about 7.5 m²/g. Although not wishing to be bound by any theory or explanation of the invention, it is currently believed that the relatively high specific surface area of the silicone particles of the invention may be at least partially the result of dissolution of the surface of the particles. Accordingly, treatment conditions are controlled to thereby control dissolution of the particles. The silicone particles may have a maximum surface area of about 30 m²/g, although the present invention is not so limited.

In an exemplary embodiment of the present invention, the silicone particles may be polyorganosilsesquioxane particles.

### Preparation of Surface-Treated Silicone Particle

The present invention provides a novel method for preparing silicone particle with excellent hydrophobic and alkali proof properties.

The method comprises mixing alkali metal ions or alkaline earth metal ions with a silicone particle suspension, and filtering and drying the mixture.

In exemplary embodiments of the invention, the silicone particle suspension is prepared by hydrolysis and condensation reaction of organotrialkoxysilane in an aqueous phase. The organotrialkoxysilane is represented by the Formula R¹Si(OR²)₃, wherein R¹ is an alkyl group having 1 to 6 carbon atoms, a vinyl group or an aryl group having 6 to 20 carbon atoms and R² is an alkyl group having 1 to 5 carbon atoms. Organotrialkoxysilanes such as represented by the Formula noted herein are commercially available.

Acid or base catalyst may be used in the hydrolysis and condensation reaction. The acid catalyst may include, but is not limited to, hydrochloric acid, nitric acid, sulfuric acid, organic acid, organochlorosilane, and the like, and combinations thereof. The base catalyst may include, but is not limited to, alkali metal, alkaline earth metal, hydrogen carbonate, ammonia, and the like, and combinations thereof. Various methods for preparing a silicone particle suspension by hydrolyzing and condensing organotrialkoxysilane in an aqueous phase in the presence of an acid or base catalyst can be used, such as the methods disclosed in Japanese Patent Nos. 1,095,382, 1,789,299, and 2,139,512, Korean Patent No. 0756676, and the like, and the present invention is not limited to any particular method.

In exemplary embodiments of the present invention, the silicone particle suspension may be prepared by a method which comprises mixing organochlorosilane with the organotrialkoxysilane to give an organochlorosilane concentration of about 100 to about 2,000 ppm, mixing the mixture with water to prepare a transparent sol solution, and maintaining a pH value of the sol solution within a range of about 8 to about 11. The method is disclosed in Korean Patent No. 0756676, the disclosure of which is incorporated herein by reference in its entirety.

In one embodiment, the silicone particle suspension may be a polyorganosilsesquioxane particle suspension.

The alkali metal ions or the alkaline earth metal ions may be mixed into the silicone particle suspension prepared from the above methods in order to treat surfaces of the silicone particles.

The alkali metal ions or alkaline earth metal ions may include elements in Group IA or IIA of the periodic table such as but not limited to Li⁺, Na⁺, K⁺, Mg²⁺, Ca²⁺, Sr²⁺, and the like, and combinations thereof. In exemplary embodiments of the present invention, an alkali metal ion of Group IA such as Na⁺, K⁺, and the like is used in an ion exchange form.

The alkali metal ions or alkaline earth metal ions may be introduced in a solution form by dissolving them into a solvent which can be mixed well with the silicone particle suspension. In an exemplary embodiment, the solvent may include water, alcohol, or a mixture thereof. The alcohol may include methanol, ethanol, isopropyl alcohol and the like. The alcohols can be used alone or in combination with one another. Any counter-ions of the alkali metal ions or alkaline earth metal ions can be used unless the counter-ions block the alkali metals or alkaline earth metals from dissolving into the solvents. Hydroxyl ions can be useful to offset the effect of remaining counter-ions. In one exemplary embodiment, the alkali metals or alkaline earth metals may be KOH, NaOH or a mixture thereof.

The concentration of alkali metal ions or alkaline earth metal ions added in the mixture may be about 70 to about 20,000 ppm. If the concentration is lower than about 70 ppm, the surface hydroxyl groups may not be sufficiently eliminated. If the concentration is higher than about 20,000 ppm, the alkali metal ions or the alkaline earth metal ions may affect other properties, since these ions are present in the form of a salt. The concentration of alkali metal ions or alkaline earth metal ions added may be higher, for example in a range from about 100 to about 15,000 ppm, and as another example about 200 to about 14,500 ppm, per total weight of silicone particles.

The silicone particle suspension which is mixed with the alkali metal ions or the alkaline earth metal ions may undergo a conventional filtering and drying procedure to obtain silicone particles surface-treated with the alkali metal ions or the alkaline earth metal ions. The methods of filtering or drying are not limited, if the particles can be recovered through these methods. In an exemplary embodiment, the drying procedure may be carried out at about 160 to about 250° C. for about 10 to about 30 hours, for example about 15 to about 25 hours. In another exemplary embodiment, the drying procedure may be carried out at about 180 to about 300° C. for about 5 to about 25 hours, for example about 10 to about 20 hours. The present invention is advantageous in that a shorter period of about 30 hours or less for drying is enough to sufficiently impart hydrophobicity on the surface of particles, compared to a conventional surface treating process for hydrophobicity which requires a thermal treatment for more than 40 hours.

The surface-treated silicone particles prepared from the above methods have an OH index value of about 0.6 or less, for example about 0.0001 to about 0.5. These particles show excellent hydrophobic and alkali proof properties. As a result, silicone particles prepared from the above methods do not dissolve in about 20% NaOH solution at room temperature for about 6 hours. In an exemplary embodiment, if the surface-treated silicon particles are placed in about 20% NaOH solution for more than 6 hours, about 5% or less of the initial weight of the particles dissolves in the about 20% NaOH solution. Treating silicone particles using a conventional method such as thermal treatment to obtain an OH index value of 0.6 or less, instead of surface-treating the silicone particles with alkali metal ions or alkaline earth metal ions, can be impractical in many commercial applications because of the long processing times that such methods require. Furthermore, if silicone particles are not surface-treated with alkali metal ions or alkaline earth metal ions, their stability in aqueous alkaline solution may drastically deteriorate, even though the silicone particles have an OH index value of 0.6 or less.

Although not wishing to be bound by any theory or explanation of the invention, it is currently believed that the alkali metal or alkaline earth metal ions can modify the surface of the silicone particles. For example, the metal cation and counter hydroxyl anion may affect the surface hydroxyl group by the way of forming a complex of metal cation and surface hydroxyl group or partially dissolving of the particles.

The surface-treated silicone particles of the present invention may be added into a coating composition or a resin composition requiring alkali proof property, since the particles have excellent hydrophobic and alkali proof properties.

The surface-treated silicone particles of the present invention may be used as an ingredient of a coating composition, a resin composition, a vector for a catalyst or medicine, a light scattering plate, and the like, since the particles have a high specific surface area.

The coating composition may be used as a coating composition for a plastic substrate, a coating composition for preventing a plate from heating, a coating agent for paint, LCD panels, and the like. The coating composition may also be used as a substitute for polyorganosilsesquioxane. The coating composition may easily be prepared by those skilled in the art.

Examples of resins useful for the resin composition may include without limitation styrenic polymer/oligomer, acrylic polymer/oligomer, urethane polymer/oligomer and the like, and combinations thereof. The amount of the silicone particles in the resin composition may be about 0.01 to about 20 wt %.

The invention may be better understood by reference to the following examples which are intended for the purpose of illustration and are not to be construed as in any way limiting the scope of the present invention, which is defined in the claims appended hereto.

### EXAMPLES

### Preparation of Silicone Particle Suspension

Methyl trichlorosilane is mixed with methyltrimethoxysilane to prepare a mixed solution having a methyl trichlorosilane content of 500 ppm. 2,800 g of ion-exchanged water is added and mixed into 500 g of the mixed solution which is then subjected to a high speed mixing for 1 minute at 10,000 rpm using a homo-mixer. Aqueous ammonia is added to the resulting mixture to adjust the pH value to 9.7. Thereafter, the mixture is allowed to stand at room temperature for 4 hours to obtain a polymethylsilsesquioxane suspension having an average particle size of 2 μm.

### Example 1

0.1% of potassium hydroxide is added to the polymethylsilsesquioxane suspension obtained by the above preparation method until the content of potassium hydroxide in the solution becomes 300 ppm per total weight of polymethylsilsesquioxane. The mixture is then stirred for 1 hour and filtered and dried at 200° C. for 20 hours.

### Example 2

Example 2 is conducted in the same manner as in Example 1 except the content of potassium hydroxide is 600 ppm per total weight of polymethylsilsesquioxane.

### Example 3

Example 3 is conducted in the same manner as in Example 1 except the content of potassium hydroxide is 3,500 ppm per total weight of polymethylsilsesquioxane.

### Example 4

Example 4 is conducted in the same manner as in Example 1 except the content of potassium hydroxide is 14,000 ppm per total weight of polymethylsilsesquioxane.

### Comparative Example 1

Comparative Example 1 is conducted in the same manner as in Example 1 except the content of potassium hydroxide is 50 ppm per total weight of polymethylsilsesquioxane.

### Comparative Example 2

Comparative Example 2 is conducted in the same manner as in Example 1 except potassium hydroxide is not added.

### Comparative Example 3

Comparative Example 3 is conducted in the same manner as in Example 1 except potassium hydroxide is not added and the mixture is dried for 48 hours.

The physical properties of the fine particles obtained are measured as follows.

(1) Hydrophobicity: Hydrophobicity is analyzed by measuring the OH index as defined by the following equation using infrared spectroscopy.

OH Index=Abs(Si—OH)/Abs(Si—CH₃)
wherein Abs(Si—OH): Si—OH peak at 3,300 to 3,700 cm⁻¹, and Abs(Si—CH₃): Si—CH₃ peak at 2,900 to 3,100 cm⁻¹.

(2) Alkali resistance: Dissolution is measured by the naked eye for 6 hours, after the particles are put in a 20% NaOH solution.

(3) Specific area: BET specific area is measured by ASAP2020 (Micrometrics Corp.) after the particles are dried at 200° C. for 5 hours under vacuum.

TABLE 1

| | | | Drying | | Alkali resistance | |
|---|---|---|---|---|---|---|
| | | KOH input | time | OH Index | (dissolution | Specific area |
| | | (ppm) | (hours) | (a.u.) | time) | (m²/g) |
| Examples | 1 | 300 | 20 | 0.49 | Not dissolved | 11 |
| | 2 | 600 | 20 | 0.34 | Not dissolved | 11 |
| | 3 | 3,500 | 20 | 0.09 | Not dissolved | 11 |
| | 4 | 14,000 | 20 | 0.08 | Not dissolved | 12 |
| Comparative | 1 | 50 | 20 | 0.65 | about 2 hours | 7 |
| Examples | 2 | 0 | 20 | 0.72 | about 1 hour | 6.7 |
| | 3 | 0 | 48 | 0.58 | about 3 hours | 7 |

As shown in Table 1, it can be seen that surface-treated polymethylsilsesquioxane particles exhibit low OH index values of 0.6 or less and do not dissolve in 20% NaOH solution. On the other hand, Comparative Example 1 in which the concentration of alkali ions is less than the range of the present invention exhibits low alkali resistance. Comparative Examples 2 and 3 without alkali surface treatment also exhibit increased OH index values and low alkali resistance. Although Comparative Example 3 exhibits an OH index of 0.6 or less, it exhibits low alkali resistance since the particles are not alkali surface-treated.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A silicone particle which has an OH index of about 0.6 or less and does not substantially dissolve in about 20% of NaOH solution at room temperature for at least about 6 hours, said OH index being defined by the following equation:
OH Index=Abs(Si—OH)/Abs(Si—CH₃)
wherein Abs(Si—OH): Si—OH peak at 3,300 to 3,700 cm⁻¹; and Abs(Si—CH₃): Si—CH₃ peak at 2,900 to 3,100 cm⁻¹.

2. The silicone particle of claim 1, wherein said OH index is in a range of from about 0.0001 to about 0.5.

3. The silicone particle of claim 1, wherein the particles exhibits no more than about 5% loss of its initial weight when left in an about 20% NaOH solution for about 6 hours.

4. The silicone particle of claim 1, wherein said silicone particle has a unit represented by the following Formula 1:
RSiO_{1.5-x}(OH)ₓ [Formula 1]
wherein R is an alkyl group having 1 to 6 carbon atoms, a vinyl group or an aryl group having 6 to 20 carbon atoms, and x is about 0 to about 1.5.

5. The silicone particle of claim 1, wherein said silicone particle is surface-treated with alkali metal ions or alkaline earth metal ions.

6. The silicone particle of claim 1, wherein said silicone particle has specific surface area at least about 7.5 m²/g.

7. The silicone particle of claim 1, wherein said silicone particle is a polyorganosilsesquioxane particle.

8. A method for preparing a silicone particle, comprising:
mixing alkali metal ions, alkaline earth metal ions, or a combination thereof with a silicone particle suspension; and
filtering and drying the mixture.

9. The method of claim 8, wherein said alkali metal ions or alkaline earth metal ions are KOH, NaOH or a combination thereof.

10. The method of claim 8, wherein said alkali metal ions or alkaline earth metal ions are mixed in an amount of about 70 to about 20,000 ppm per total weight of silicone particles present in the silicone particle suspension.

11. The method of claim 8, wherein said silicone particle suspension is prepared by hydrolysis and condensation reaction of organotrialkoxysilane in an aqueous phase.

12. A coating composition comprising the silicone particle of claim 1.
